(19) United States
(12) Patent Application Publication
(10) Pub. No.: US 2002/0032610 A1
(43) Pub. Date: Mar. 14, 2002

(54) Method for providing automated delivery of a response to a pricing inquiry

(76) Inventors: Stephen E. Gold, Pleasanton, CA (US); John H. Miller, San Marino, CA (US); Jan McCleery, Sunnyvale, CA (US)

Correspondence Address: OPPENHEIMER WOLFF & DONNELLY, P. O. BOX 10356, PALO ALTO, CA, 94303, US

(21) Appl. No.: 09/849,076

(22) Filed: May 3, 2001

Related U.S. Application Data
(60) Provisional application No. 60/201,482, filed on May 3, 2000.

(51) Int. Cl. G06F 17/60

(52) U.S. Cl. 705/20

(57) ABSTRACT

A method is afforded for providing automated delivery of a response to a pricing inquiry. When an inquiry requesting a price of an item is received, a price of the item based on a set of predetermined criteria is determined. The determined price is then modified based on the application of various predetermined rules. The modified price is then selectively compared to a target price and a response is provided. The response is a price quote that reflects a weighted price, the weighted price being a selection of either the modified price or the target price.

This application is claims the benefit of U.S. Provisional Application No. 60/201,482 filed May 3, 2000 and entitled Pricing Rules, the entire content of such Application being expressly incorporated herein by reference.

### FIELD OF THE INVENTION

The present invention relates generally to pricing systems and more particularly to a method for providing automated delivery of a response to a pricing inquiry.

### BACKGROUND OF THE INVENTION

Historically, pricing has been dependent upon static price tables. These price tables are generally updated periodically. The tables may be supplemented by manually negotiated contractual price rates. Pricing has generally been communicated via e-mail, static web HTML pages, fax, phone, and printed material distributed via conventional delivery methods.

Price exceptions are frequently handled on a case by case basis via human intervention. Thus, the price exception might be different depending upon the case presented. Resultantly, price exceptions are rarely consistent and are often unpredictable.

Attempts to automate price management include the electronic publication of price tables, the maintenance and administration of manually negotiated contracts, and the ability to interactively allow an individual the ability to override price responses. Consequently, a need exists in the field of commerce for a systematic approach that ensures that pricing complies to stated business practices, rules, procedures, etc.

### SUMMARY OF THE INVENTION

Accordingly, an object of the present invention is to provide automated generation and delivery of a response to a pricing inquiry.

Another object of the present invention is to provide a system having consistent pricing methods and predictable responses to pricing inquiries.

It is a further object of the present invention to provide a convenient electronic forum for posing pricing inquiries.

Still another object of the present invention is to provide an efficient response to pricing inquiries.

Briefly, a preferred embodiment of the present invention provides a method and system for automated delivery of a response to a pricing inquiry. In response to an inquiry requesting a price of a particular item, a price of the item based on a set of predetermined criteria is determined. The set of predetermined criteria may include terms of a contract, terms of a market price program, terms of a requote, or selections from a reference price table. The determined price is then modified based on the application of various predetermined rules. The various predetermined rules may include a set of business rules, a set of value added services rules, or a set of price channel conversion rules. The modified price is then selectively compared to a target price and a response is provided. The response is a price quote that reflects a weighted price, the weighted price being a selection of either the modified price or the target price. The weighted price may include a highest price, a lowest price, or an initially quoted price. Further, application of the various predetermined rules may result in the determined price.

An advantage of the present invention is that a comprehensive solution to answering pricing inquiries is provided.

Another advantage of the present invention is that users may obtain a rapid, accurate response to a pricing inquiry.

A further advantage of the present invention is the incorporation of established business practices, processes, and models into an automated pricing system.

These and other objects and advantages of the present invention will become clear to those skilled in the art upon review of the following specification, the accompanying drawings and the appended claims.

### BRIEF DESCRIPTION OF THE DRAWINGS

The invention will be better understood when consideration is given to the following detailed description thereof. Such description makes reference to the annexed drawings wherein:

FIG. 1 is a flowchart of a pricing inquiry system in accordance with a presently preferred embodiment of the present invention;

FIG. 2 is a schematic illustration of a reference pricing table in accordance with the embodiment of FIG. 1;

FIG. 3 is a screen capture of a pricing summary interface in accordance with the embodiment of FIG. 1;

FIG. 4 is a screen capture of a pricing summary options sorting page in accordance with the embodiment of FIG. 1;

FIG. 5 is a screen capture of a default new business rule editor page in accordance with the embodiment of FIG. 1;

FIG. 6 is a screen capture of a business rule table page with user selections in accordance with the embodiment of FIG. 1;

FIG. 7 is a screen capture of an edit pricing table interface in accordance with the embodiment of FIG. 1;

FIG. 8 is a screen capture of a commission editing screen in accordance with the embodiment of FIG. 1; and

FIG. 9 is a flowchart of a method for providing automated delivery of a response to a pricing inquiry in accordance with the embodiment of FIG. 1.

### BEST MODE FOR CARRYING OUT THE INVENTION

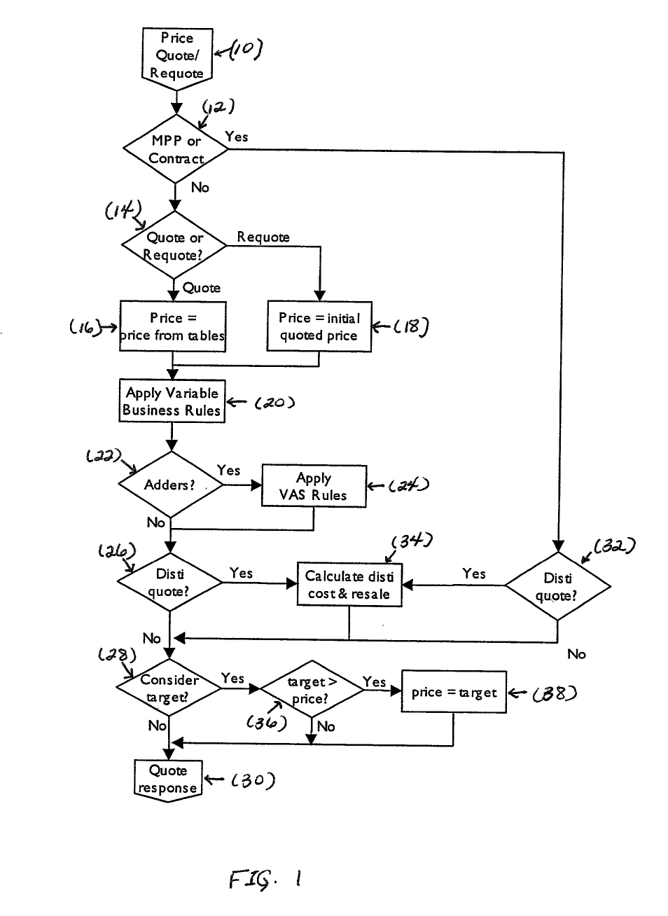

The present invention is a method for providing automated delivery of a response to a pricing inquiry. A preferred embodiment of the present invention is illustrated in FIGS. 1-9.

FIG. 1 is a flowchart of a pricing inquiry system in accordance with a presently preferred embodiment of the present invention. As illustrated in response to a pricing inquiry, which may for example be related to a previously rendered price quote or a new price quote (Block 10), it is first determined whether the quote is to be given subject to a market price program (MPP) or a contract (Block 12). Where it is a pricing inquiry that is not associated with an MPP or contract, the system asks whether it is a pricing quote or a pricing requote (Block 14). Where it is a pricing quote, the system selects a price from a predetermined set of pricing tables (Block 16). Where it is a pricing requote, the system selects a price that is equal to the initial quoted price (Block 18). A set of variable business rules are then applied to the pricing requote or the pricing quote (Block 20).

The system then determines whether any adders to the pricing quote or requote are relevant (Block 22). If adders are applicable, the system applies value added services (VAS) rules (Block 24). The system next asks whether the quote is a pricing quote for a distributor (Block 26). Where the quote is not for a distributor, the system determines whether it should consider a predetermined target price (Block 28) and if not it responds to the inquiry with a quoted price (Block 30) where a target price is not considered.

Similarly, where the pricing quote is associated with an MPP or contract as determined at Block 12, the system asks whether the quote is for a distributor (Block 32). If it is not for a distributor, the system asks whether a target should be considered (Block 28) and responds to the inquiry with a quote (Block 30) without considering the target price. On the other hand, where the quote is for a distributor, the distributor cost and resale are calculated (Block 34) and the system asks whether a target should be considered (Block 28). If not, the price inquiry is responded to with a quote (Block 30). Where a target is to be considered, the system determines whether the target is greater than the price from the pricing table (Block 36). If it is greater, the price is set to equal the target (Block 38) and this price is quoted in response to the inquiry (Block 30). Where the target is not greater than the price from the pricing table, the price from the pricing table is used to respond to the inquiry with a quote (Block 30).

In the preferred embodiment of the present invention, price requests (i.e. inquiries) are matched against a contract, should there be an existing valid contractual agreement. Such agreements may be in the form of an end user agreement applied to the end user or targeted benefactors, or distributor users buying under a blanket contract or Market Price Program (MPP). Otherwise, the price request can be compared to a reference pricing table. A price may be identified from a reference pricing table based on quantity and timeframe.

Once a price has been identified, either from an MPP, contract, or reference pricing table, business rules variables may be applied to the price. The price may be modified based on data filters, quantifiers, systematic exceptions to an organizations stated pricing policy or desired practice. Further, the price or modified price may be further adjusted by applying value added services (VAS) rules. These rules can accommodate the design, application, and administration of price adders associated with value added services, such as special handling, packaging, programming, etc.

When a final price has been determined, modified and adjusted in whatever way necessary, the price may be converted from a standard pricing, such as an original equipment manufacturer (OEM) price, into distributor resale and distributor cost. Further, a conversion may be made from distributor resale to distributor cost based on design registration versus distributor. In addition, contract costs can be utilized appropriately.

Once the price has been converted, the price can be provided in response to an automated request to respond to target pricing based on user input criteria, such as target price, competitor, competitor part number, etc. Otherwise, the price may be provided in response to an inquiry that either does or does not address a target price. Further, where the price is more than the target price, the higher price, or otherwise weighted price, may be provided in response to the inquiry. For example, where the inquiry involves a requote, the requote will be more heavily weighted than a higher price. Accordingly, the requote may be provided in response to the inquiry, rather than the higher price. Where the price quote is not being provided for a distributor, or distributor related activity, the price may not be converted. In this scenario, the price, as previously modified where applicable, will be quoted based on the target price or modified reference table price, depending on which of the two or more prices is higher.

The present invention provides systematic automation, via an intuitive graphical user interface, of business rules by which pricing can be generated in real-time, based on organizational selected criteria. The business rules of an organization may be effectively administered, generated, applied, and maintained. Further, price inquiries may be filtered utilizing organizational defined criteria such as customer identification, customer category, customer classification, geography, sales channel, contract, competition, target pricing, quantity, date, delivery schedule, part identification, product family, value added requirements, etc.

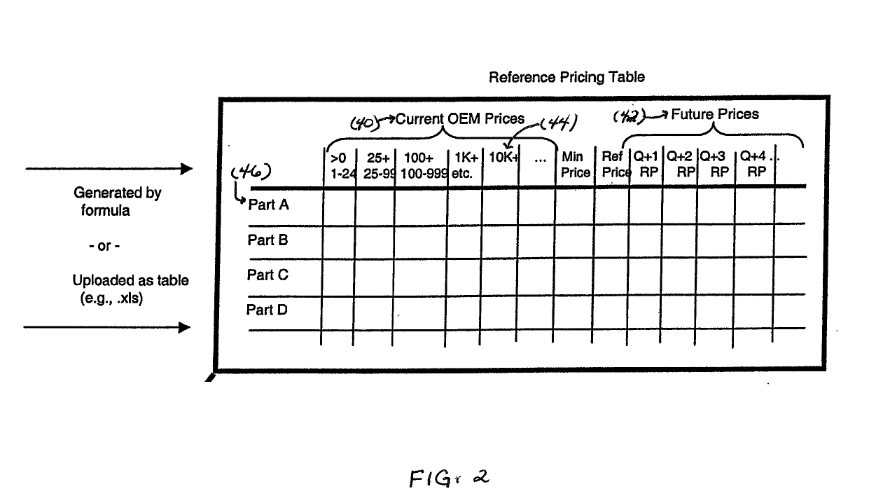

FIG. 2 is a schematic illustration of a reference pricing table in accordance with the embodiment of FIG. 1. The pricing table may include various pricing formats, such as current OEM prices 40 and future prices 42, as indicated on the reference pricing table shown. Each column 44 in the reference pricing table may be sorted according to quantity break. In other words, a set of prices is displayed for an item depending on whether a price is requested for 1-24 of that item, 25-99 of that item, and so on. Each row 46 can represent the part (i.e. item) for which a price quote is requested. The prices displayed in the reference pricing table may be generated utilizing a predetermined formula.

Where no contracts or MPPs exist, the pricing tables may be utilized to derive the OEM price (i.e. standard price term). Pricing tables may include current price tables containing OEM prices for each part by quantity break, a futures pricing table containing reference prices by timeframe, a table containing other price points such as distributor book cost, a reference price to base future pricing conversions, manufacturer costs, minimum costs, or other user-definable price points. The initial OEM price may be calculated from the pricing table (i.e. reference pricing table) based on quantity, such as quote-for-buy quotes, or from future pricing tables, such as when the price quote is requested for a future timeframe. The future pricing table may include reference points for the respective timeframes. Future pricing may be calculated by utilizing the following formula: Price=OEM Price * (Future Reference Price/Current Reference Price). Once the initial OEM price is derived from the pricing tables, business rules may be applied thereto.

A set of variable business rules may be applied after the initial OEM price is derived utilizing the pricing tables. Business rules can apply to all users and may combine various filters or criteria. Filters and rules may be different based on the nature of the price inquiry, namely primary (e.g. price quote) or secondary (e.g. price requote). For details regarding the various reference tables, the Provisional Application No. 06/201,482 may be consulted, which has been incorporated herein by reference as previously discussed.

Business rules may be stored in a table, such as a table labeled Business Rule_Table. The following types of business rules may be supported:

| | |
|---|---|
| Colunm Rule: | new price = OEM price for ‘n = amount’ quantity breaks to |
| | the right (greater) than the quoted quantity |
| ColumnX Rule: | new price = price from named colunm (e.g. if X (amount) = 1, |
| | price is from Column 1 of the pricing table) |
| Discount Rule: | new price = OEM price * (1 − amount %) |
| Incremental Rule: | new price = price_point.price / (1 − amount %) (field_num |
| | indicates which price_point is used.) |
| Markup Rule: | new price = OEM price * (1 + amount %) |
| Please Call: | new price = n/a |
| Sale Rule: | new price = min (OEM price, amount) |

The selected criteria for the business rules may include items such as customer, customer class, geography, channel of distribution, part, part family, quantity, competitor, price targets, etc. The business rules may accommodate the application of tabular pricing and associated derivatives (i.e. shift one column price to the right for an export account), incremental pricing (e.g. margin, mark-up, discount, etc.), named pricing (e.g. $1.23), narrative pricing (e.g. please call), time dependent pricing (e.g. current, future, budgetary), deal parametric pricing (e.g. quote for buy, quote for bid, quantity, delivery, etc.), customer dependent (contracts, discounts, rebates), and promotional pricing (e.g. special sale, date dependency, package, etc.).

An organization may elect to consider target pricing. If targets are considered, the automated system, which may be a series of modules, such as the Price Management Modules, determines whether the calculated price is less than the target price. The system can select the target price rather than the calculated price when the target price is greater that the calculated price. Further, the system can also select the lesser of the two prices where the organization desires such a consequence. The target pricing may generally be used if the target price is greater than or equal to the to-be-quoted price. If the quote is for a debit, the target can be either a target resale or target cost. The target resale may be the default, while the target cost can be optional. In either scenario, the OEM price can be calculated, converted to resale or cost and compared against the target.

Conversion factors, where distributor resale and distributor costs are being calculated, may be identified in a table, such as a Pricing_Conversion table. There may be four conversion factors per quantity break. One may convert from the calculated OEM prices to distributor resale and three may convert from distributor resale to distributor cost. The price may be converted from the OEM price to distributor resale where there is a markup. The price may be converted from distributor resale to distributor cost where there is a registration and a registered distributor is concerned, there is a registration and the distributor concerned is not registered, or there is not registration. The calculations for each type of conversion may be as follows:

Markup from OEM price to distributor resale: for example, if the company used a markup of 25%, the equation may be: Distributor resale=OEM price * (1+0.25). If the company uses “margin” to calculate resale, such as Distributor resale=OEM price/(1−GPM) then the markup percent/factor may be equal to GPM/(1−GPM). Conversion from Distributor Resale to Distributor Cost: Distributor cost=Distributor resale * (1−factor). If the “please call” rule is set, distributor prices may not be calculated. After the distributor cost and distributor resale price have been calculated, the system may perform checks, such as:

distributor cost cannot be greater than the Distributor Book Cost. Therefore, If Distributor Cost>=DBB, Distributor cost=DBB.

Re-Calculate Distributor Resale if Target Cost was used: If target cost is used, an additional conversion can occur at the end of the calculations to recalculate Distributor Resale from the new Distributor Cost, such as Distributor resale=Distributor cost/(1−factor).

The conversion factors can be different based on the quantity break. However, due to business rules and other potential alterations (i.e. modifications), the final OEM price calculated can be in a different quantity break column range than the quantity requested. In other words, the business rules can slip the column either directly or indirectly. The quantity break used by the pricing algorithm may be based on the final calculated OEM price (excluding adders). Therefore, if the quantity falls in column 2, for example, and no business rules are applied, the Distributor conversion factors used can be from the conversion table for quantity_break 2. However, if business rules are applied which move the final OEM price to another column, the Distributor conversion factors for that column can be used. Hence, a calculation can be made to determine where in the pricing table the end price belongs. Further, this calculation can also take into account future pricing for forward pricing calculations.

In addition, if a target price is to be considered, the system may review the calculated price versus the target. Where a requote is concerned, the system can check to ensure that the user has not entered a target price greater than the previously quoted price. If the user has entered a target price greater than the previously quoted price, the target can be ignored.

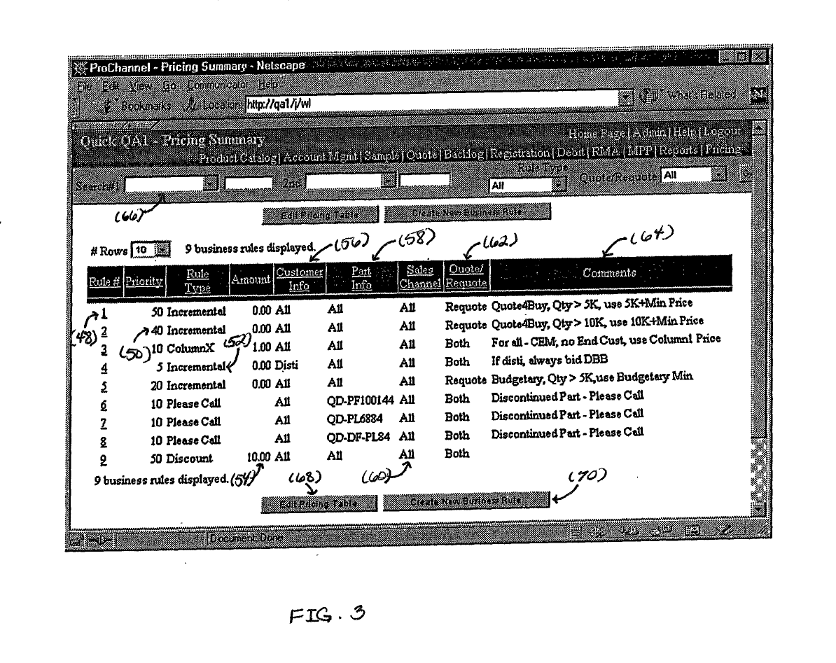

FIG. 3 is a screen capture of a pricing summary interface in accordance with the embodiment of FIG. 1. The pricing summary screen can provide a summary of the active business rules. It can allow the user to view or edit the pricing table, as well as to view or edit existing business rules. Further, the user may add new business rules via this interface. The screen may include items such as a rule number 48, a priority number 50, a rule type 52, and amount 54, customer information 56, part information 58, sales channel 60, quote/requote selection 62, comments 64, etc. The user may perform various functions or make various selections utilizing the pricing summary screen, such as performing a search 66. Further, the user may select the edit pricing table button 68 or the create new business rule button 70 in order to perform further functions.

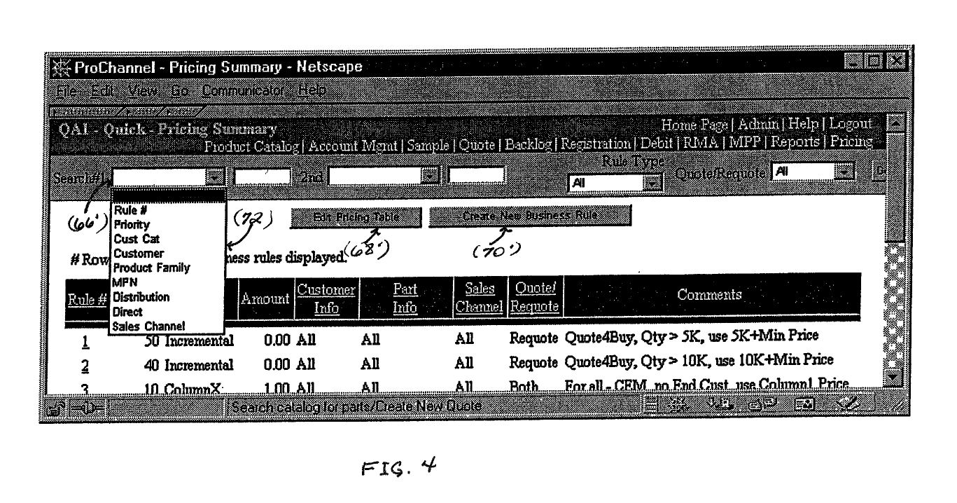

FIG. 4 is a screen capture of a pricing summary options sorting page in accordance with the embodiment of FIG. 1. As shown, the user may perform a search 66′ by selecting a search option from the search pull down menu 72.

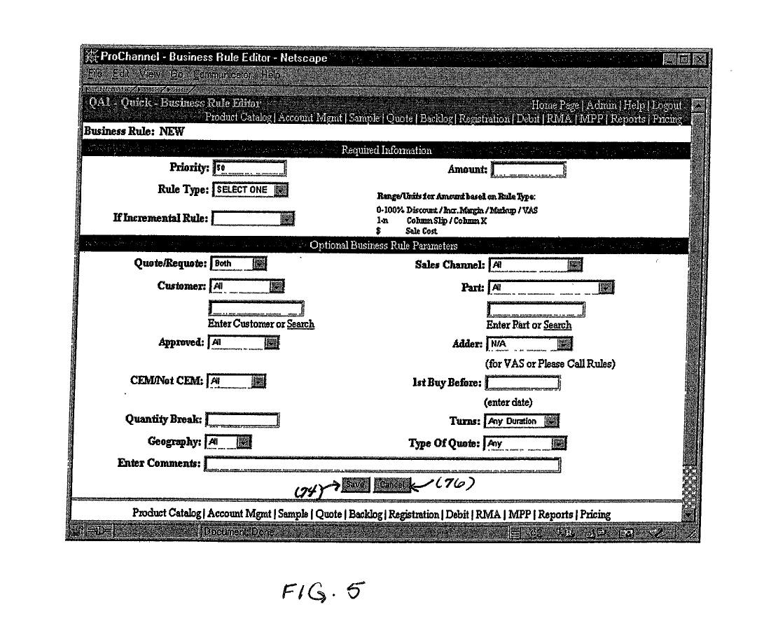

FIG. 5 is a screen capture of a default new business rule editor page in accordance with the embodiment of FIG. 1. If the user hits the create new business rule button 70 (shown in FIG. 3 & 4), the user can view the Business Rule Editor populated with various defaults, as shown in FIG. 5. Utilizing this screen, the user can enter any information desired. Generally, the user will enter information pertinent to his or her organizations business rules, procedures, etc. The user may choose to hit the save button 74 or cancel button 76 in order to save or cancel the edits to the existing business rules. The user can view existing business rules and make changes and either save those changes, in other words update the current business rule, or use the new parameters to create a new business rule. The user may also delete the existing rules.

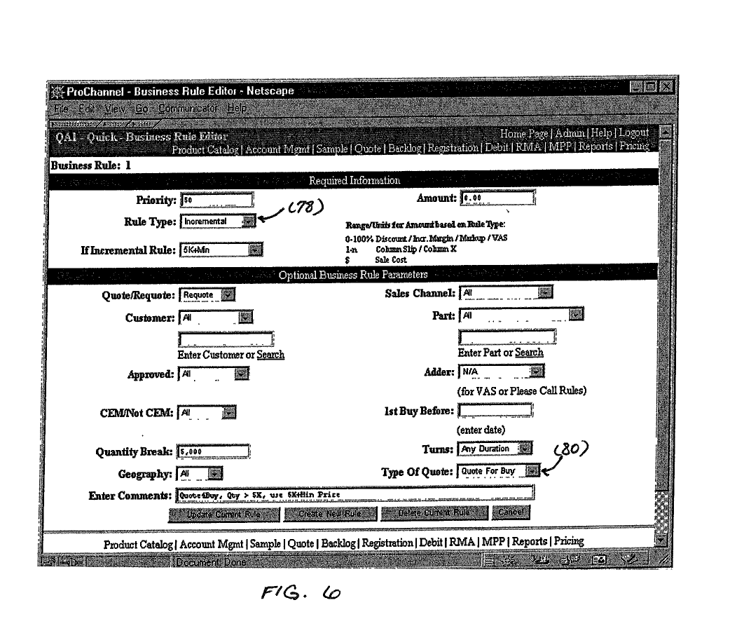

FIG. 6 is a screen capture of a business rule table page with user selections in accordance with the embodiment of FIG. 1. The current screen indicates selections made by the user, for example the user has chosen incremental 78 for a rule type and quote for buy 80 for the type of quote. The table to be created from this particular screen can define the business rules to be applied after a resale price is identified from the pricing tables. This particular screen may contain both business rules and VAS rules.

If the column slip is greater than the remaining number of columns, the price in the maximum column may be used. The please call rule can set a flag that the part cannot be priced and, similar to a target not met, the user may be asked to “call marketing”, “call customer service department”, etc. The sale rule, which can be used for a special deal on particular parts, can have a specific part identified. Once all applicable rules are retrieved, the rule with the lowest ranking may be applied. In other words, the rule with ranking #1 may be the first or highest ranking. If more than one rule has the same ranking, the rule that results in the lowest price may be used.

All business rules that match the current quote information may be retrieved. If a business rule contains a null field, then that rule may be used regardless of the quote parameters. For example, if program_oid is null for a business rule, the rule may be applicable regardless of the program being quoted. If it is not null, then ideally the rule matches the quote program. The rule type is generally the type of rule. For example, “amount,” such as percentage, such as incremental margin, discount, vas rule, price, such as sale rule, or integer ‘n’, such as column rule.

Once a price is determined, applicable VAS rules and adder costs are applied to the previously calculated (i.e. determined) price. If a quote is requested where a distributor is the customer, the business rule needed may be: return the price=DBB (Distributor book cost). All other fields in this case may be null.

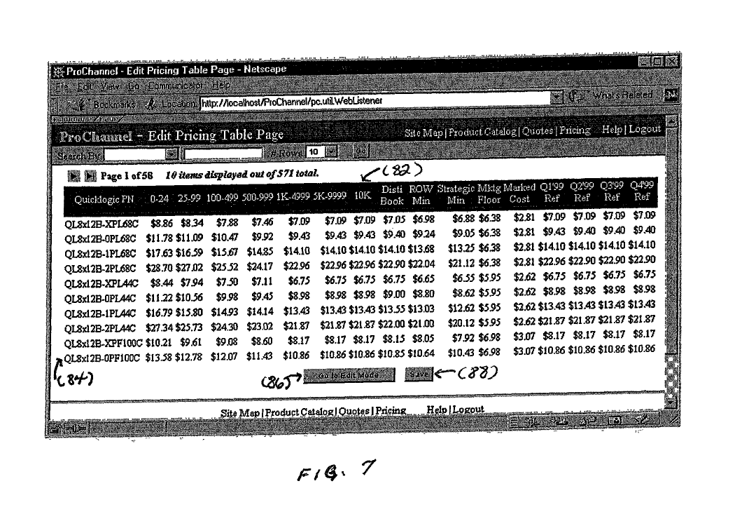

FIG. 7 is a screen capture of an edit pricing table interface in accordance with the embodiment of FIG. 1. The various columns 82 represent a plethora of prices associated with each item (i.e. part) in the various rows 84. From this screen, the user may choose to edit the pricing table by selecting the go to edit mode button 86 save the pricing table by selecting the save button 88. A Quantity_Break table, such as one utilized to generate the pricing table in FIG. 7, can give the quantity breaks that are used in the pricing table and Business_Rule table. Quantity break columns can vary by family. For instance, if Product_Family_OID is null, the quantity breaks identified will be defaulted for all families not specifically identified. As another example, for Release 0.5 initial beta, there will be one set of quantity breaks so product_family_oid will be null.

The pricing table may contain prices for the current time period as well as all quote-to-buy quoting activities. A Price_Point_Field table may define the price_points used by the customer. Some fields may be used as defined (“DEFINED”), while others may be used per the customer's wishes. Further, a Price_Point table may contain key price points and costs that are used in pricing calculations, while a Pricing_Timeframe table can give the effective dates that are used in the Future_Pricing table. For companies with quarterly time frames, these dates are generally Jan. 1, 1999, Apr. 1, 1999, Jul. 1, 1999, Oct. 1, 1999, etc. If companies use half-years, the dates may be Jan. 1, 1999, Jul. 1, 1999, Jan. 1, 2000, etc.

A Future_Pricing table may be used to calculate prices for future timeframes for budgetary and forward pricing quotes. The future reference prices may have effective timeframes. Thus, for a company that calculates part cost changes by quarter, the effective dates in this table may be today plus one quarter, today plus two quarters, etc. This table may contain reference prices for each part for each time period (e.g. each quarter). The quantity break resale costs and price_point prices for future timeframes may be calculated from the new reference price/price point_price (field_min=1).

Future timeframe pricing can be calculated by multiplying the current price by the ration of: Future Ref Price/Current Ref Price. For example:

Future OEM price=(Current OEM price) * ((Future Ref Price)/(Current Ref Price)) Accordingly, if the Current Ref Price for a part is $3.48 (price_point.price where field_num=1) and the future Reference Price is $3.40 three quarters from today, and the current OEM price for the given quantity is $6.50 and minimum price is $3.48, then the quarter three (Q3) prices for the same quantity would be:

Q3 OEM price=$6.50*(3.40/3.48)=$6.50*0.977=$6.35

Q3 Minimum price=$3.48*(3.40/3.48)=$3.48

These rules can be used to calculate future pricing for any of the prices in the price_point table (e.g. field min, Distributor book cost, etc.) for business rule calculations.

The Pricing_Conversion table may be used to convert between calculated OEM prices, Distributor resale, and Distributor cost. Conversions may be from the OEM price to Distributor resale, from Distributor resale to Distributor cost, or from Distributor resale to Distributor cost for registered parts where the distributor is not the registered distributor.

The present invention may be utilized equally as well in determining commissions. A commissions based rule (percentages) can be based on territory, such as geography, customer, customer category, part, product family, etc. The present invention may also be implemented to determine when to apply a rule based on matching transactional data plus rule priority.

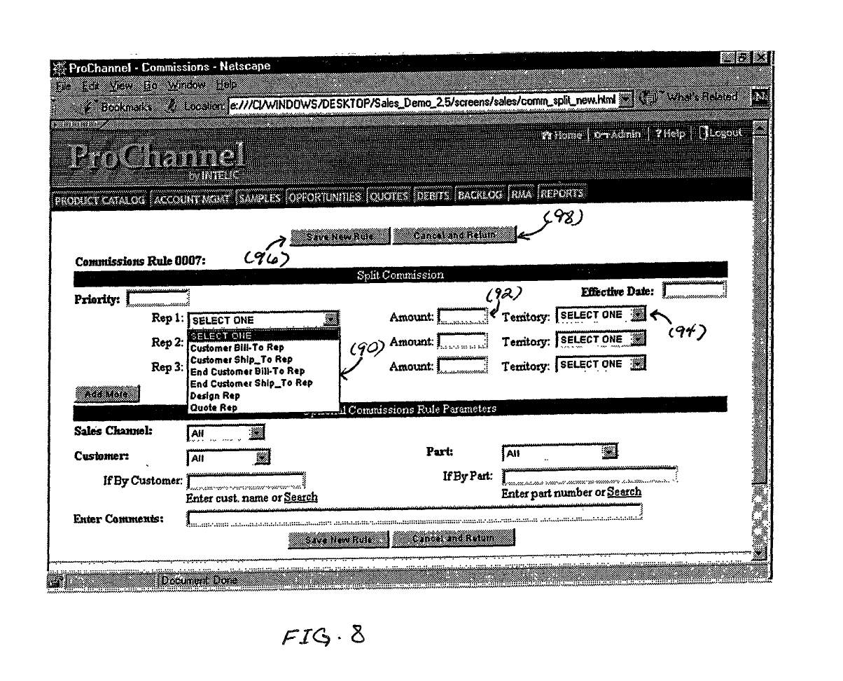

FIG. 8 is a screen capture of a commission editing screen in accordance with the embodiment of FIG. 1. As shown, the user may select items associated with a representative from a pull down menu 90, as well as an amount 92 and territory 94 associated with each representative. The user may save the new rule by selecting the save new rule button 96 or cancel and return to the previous screen by hitting the cancel and return button 98.

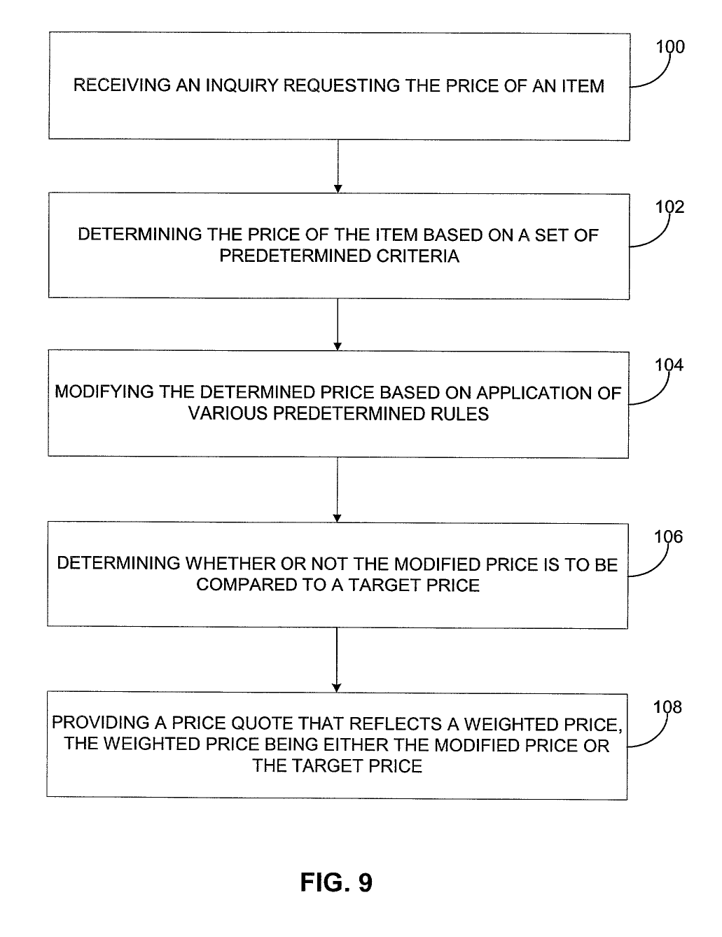

FIG. 9 is a flowchart illustrating a method for providing automated delivery of a response to a pricing inquiry in accordance with the embodiment of FIG. 1. An inquiry requesting a price of an item is received (Block 100). A price of the item based on a set of predetermined criteria is determined (Block 102). The determined price is then modified based on the application of various predetermined rules (Block 104). The modified price is compared to a target price (Block 106). A response is then provided to the inquiry (Block 108). The response is a price quote that reflects a weighted price, the weighted price being a selection of either the modified price or the target price.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for providing automated delivery of a response to a pricing inquiry comprising the steps of:
(a) receiving an inquiry requesting the price of an item;
(b) determining the price of the item based on a set of predetermined criteria;
(c) modifying the determined price based on application of various predetermined rules;
(d) determining whether or not the modified price is to be compared to a target price; and
(e) providing a price quote that reflects a weighted price, the weighted price being either the modified price or the target price.

2. A method for providing automated delivery of a response to a pricing inquiry as recited in claim 1, wherein application of the various predetermined rules results in said determined price.

3. A method for providing automated delivery of a response to a pricing inquiry as recited in claim 1, wherein said predetermined criteria is selected from at least one of the group consisting of terms of a contract, terms of a market price program, terms of a requote, and selections from a reference price table.

4. A method for providing automated delivery of a response to a pricing inquiry as recited in claim 1, wherein said various predetermined rules are selected from at least one of the group consisting of a set of business rules, a set of value added services rules, and a set of price channel conversion rules.

5. A method for providing automated delivery of a response to a pricing inquiry as recited in claim 4, wherein said set of business rules is comprised of filter criteria selected from information from at least one of the group consisting of customer identifier, customer category, customer classification, geography, sales channel, contract, competition, target pricing, quantity, date, delivery schedule, part identifier, product type, product family, and value added requirements.

6. A method for providing automated delivery of a response to a pricing inquiry as recited in claim 4, wherein said price channel conversion rules are applied where the inquiry is received from a distributor.

7. A method for providing automated delivery of a response to a pricing inquiry as recited in claim 1, wherein the weighted price is selected from at least one of the group consisting of a highest price, lowest price, and an initially quoted price.

8. A method for providing automated delivery of a response to a pricing inquiry as recited in claim 1, wherein determining a price of the item based on predetermined criteria further comprises the sub-steps of ascertaining whether the predetermined criteria involves terms of a market price program or terms of a contract, or terms of a requote or selections from a reference price table.

9. A method for providing automated delivery of a response to a pricing inquiry as recited in claim 8, wherein ascertaining whether the predetermined criteria involves terms of a market price program or terms of a contract further comprises the sub-steps of ascertaining whether the inquiry involves a distributor, wherein involvement of a distributor results in application of a set of price channel conversion rules.

10. A method for providing automated delivery of a response to a pricing inquiry as recited in claim 9, wherein said price channel conversion rules are selected from at least one of the group consisting of distributor cost and distributor resale.

11. A method for providing automated delivery of a response to a pricing inquiry as recited in claim 8, wherein ascertaining whether the predetermined criteria involves terms of a requote or selections from a reference price table further comprises the sub-steps of providing a quote response that reflects an initial quoted price where the criteria involves terms of a requote and providing a quote response that reflects one of a plurality of selections from the reference price table where the criteria does not involve terms of a requote.

12. A method for providing automated delivery of a response to a pricing inquiry as recited in claim 1, wherein modifying the determined price based on application of said various predetermined rules further comprises the steps of applying one or more of a plurality of business rule types where a set of business rules apply, applying one of a plurality of value added services charges where a set of value added services rules apply, applying a conversion factor where a set of price channel conversion rules applies.

13. A method for providing automated delivery of a response to a pricing inquiry as recited in claim 12, wherein the plurality of business rule types is selected from at least one of the group consisting of a column rule, a columnX rule, a discount rule, an incremental rule, a markup rule, a please call rule, and a sale rule.

14. A method for providing automated delivery of a response to a pricing inquiry as recited in claim 12, wherein the plurality of value added services charges are dependent upon services selected from at least one of the group consisting of special handling, packaging, and programming.

15. A method for providing automated delivery of a response to a pricing inquiry as recited in claim 12, wherein the conversion factor is selected from at least one of the group consisting of a markup from an OEM price to a distributor resale factor and a conversion from a distributor resale to a distributor cost factor, wherein the conversion from the distributor resale to the distributor cost factor is dependent on distributor registration.

16. A computer program embodied on a computer readable medium for providing automated delivery of a response to a pricing inquiry comprising:
(a) a code segment that receives an inquiry requesting a price of an item;
(b) a code segment that determines a price of the item based on a set of predetermined criteria;
(c) a code segment that modifies the determined price based on application of various predetermined rules;
(d) a code segment that determines whether or not to compare the modified price to a target price; and
(e) a code segment that provides a price quote that reflects a weighted price, the weighted price being either the modified price or the target price.

17. A computer program embodied on a computer readable program for providing automated delivery of a response to a pricing inquiry as recited in claim 16, wherein application of the various predetermined rules results in a code segment that provides said determined price as the response to the inquiry.

18. A computer program embodied on a computer readable program for providing automated delivery of a response to a pricing inquiry as recited in claim 16, wherein said predetermined criteria is selected from at least one of the group consisting of terms of a contract, terms of a market price program, terms of a requote, and selections from a reference price table.

19. A computer program embodied on a computer readable program for providing automated delivery of a response to a pricing inquiry as recited in claim 16, wherein said various predetermined rules are selected from at least one of the group consisting of a set of business rules, a set of value added services rules, and a set of price channel conversion rules.

20. A computer program embodied on a computer readable program for providing automated delivery of a response to a pricing inquiry as recited in claim 19, wherein said set of business rules is comprised of a filter criteria code segment selected from information from at least one of the group consisting of customer identifier, customer category, customer classification, geography, sales channel, contract, competition, target pricing, quantity, date, delivery schedule, part identifier, product type, product family, and value added requirements.

21. A computer program embodied on a computer readable program for providing automated delivery of a response to a pricing inquiry as recited in claim 19, wherein said price channel conversion rules are applied where the inquiry is received from a distributor.

22. A computer program embodied on a computer readable program for providing automated delivery of a response to a pricing inquiry as recited in claim 16, wherein the weighted price is selected from at least one of the group consisting of a highest price, lowest price, and an initially quoted price.

23. A system for providing automated delivery of a response to a pricing inquiry comprising:
(a) means for receiving an inquiry requesting a price of an item;
(b) means for determining a price of the item based on a set of predetermined criteria;
(c) means for modifying the determined price based on application of various predetermined rules;
(d) means for selectively comparing the modified price to a target price; and
(e) means for providing a pri quote that reflects a weighted price, the weighted price being either the modified price or the target price.

24. A method for providing automated delivery of a response to a pricing inquiry as recited in claim 23, wherein application of the various predetermined rules results in said determined price.

25. A method for providing automated delivery of a response to a pricing inquiry as recited in claim 23, wherein said predetermined criteria is selected from at least one of the group consisting of terms of a contract, terms of a market price program, terms of a requote, and selections from a reference price table.

26. A method for providing automated delivery of a response to a pricing inquiry as recited in claim 23, wherein said various predetermined rules are selected from at least one of the group consisting of a set of business rules, a set of value added services rules, and a set of price channel conversion rules.

27. A method for providing automated delivery of a response to a pricing inquiry as recited in claim 26, wherein said set of business rules is comprised of filter criteria selected from information from at least one of the group consisting of customer identifier, customer category, customer classification, geography, sales channel, contract, competition, target pricing, quantity, date, delivery schedule, part identifier, product type, product family, and value added requirements.

28. A method for providing automated delivery of a response to a pricing inquiry as recited in claim 26, wherein said price channel conversion rules are applied where the inquiry is received from a distributor. A method for providing automated delivery of a response to a pricing inquiry as recited in claim 23, wherein the weighted price is selected from at least one of the group consisting of a highest price, lowest price, and an initially quoted price.
